(19) United States
(12) Patent Application Publication
(10) Pub. No.: US 2025/0067859 A1
(43) Pub. Date: Feb. 27, 2025

(54) ZOOM OPTICS FOR LASER-BASED RANGEFINDING INSTRUMENTS AND DEVICES

(71) Applicants: Laser Technology, Inc., Centennial, CO (US); Kama-Tech (HK) Limited, Hong Kong (HK)

(72) Inventors: Takamasa Suzuki, Saitama (JP); Naomi Watanabe, Saitama (JP); Roger Corn, Morrison, CO (US); Eric A. Miller, Englewood, CO (US); Jeremy G. Dunne, Parker, CO (US)

(73) Assignees: Laser Technology, Inc., Centennial, CO (US); Kama-Tech (HK) Limited, Hong Kong (HK)

(21) Appl. No.: 18/453,774

(22) Filed: Aug. 22, 2023

(51) Int. Cl. G01S 7/51; F41G 3/06; G02B 19/00

(52) U.S. Cl. CPC G01S 7/51; F41G 3/065; G02B 19/0009; G02B 19/0047

(57) ABSTRACT

A zoom optics structure for implementation in a laser-based rangefinding instrument provides a magnified image of a target. The structure disclosed can also serve to magnify a reticle or other information on an in-sight display in conjunction with the magnified target image. The zoom optics structure disclosed is also amenable to rangefinding instruments incorporating ballistics interfaces and those having image stabilization.

### CROSS REFERENCE TO RELATED PATENT APPLICATIONS

The present invention is related to the following commonly owned U.S. Pat. No. 7,349,073 issued Mar. 25, 2008 for: “Efficient Optical System and Beam Pathway Design for Laser-Based Distance Measuring Device”; U.S. Pat. No. 7,450,282 issued Nov. 11, 2008 for: “High Precision Optical System and Beam Pathway Design for a Laser-Based Distance Measuring Device”; U.S. Pat. No. 8,411,257 issued Apr. 2, 2013 for: “Folded Path Laser Rangefinder Architecture and Technique Incorporating a Single Circuit Board for Mounting of Both Laser Emitting and Detecting Elements”; U.S. Pat. No. 9,151,603 issued Oct. 6, 2015 for: “Compact Folded Signal Transmission and Image Viewing Pathway Design and Visual Display Technique for Laser Rangefinding Instruments”; and U.S. Ser. No. 11,168,982 issued Nov. 9, 2021 for: “Laser-Based Rangefinding Instrument”, the foregoing disclosures of which patents are herein incorporated by these references in their entirety as if fully disclosed herein.

### BACKGROUND OF THE INVENTION

The present technology relates, in general, to the field of laser-based range finding instruments. More particularly, the present technology relates to the provision of zoom optics to laser-based range finding instruments and devices.

Laser-based rangefinders, such as those designed and produced by Laser Technology, Inc., operate to calculate distance by measuring the time of flight of very short pulses of infrared light. That is, a measurement is made as to the time it takes one or more laser pulses to travel to a target and back with a precise time base. With knowledge of the constant speed of light, the distance the laser pulses have traveled can then be calculated.

In order to increase accuracy, such laser rangefinders are designed to process multiple pulses in a single measurement period. Target acquisition times typically range from 0.3 to 0.7 seconds, although shorter or longer time periods may be employed. Sophisticated accuracy validation algorithms are then utilized to ensure reliable distance measurements and eliminate spurious signals due to noise and other factors.

Traditional laser rangefinders can have difficulty measuring distant targets, especially when the target is small or moving. In these instances, the laser pulses can reflect off the target or other objects in the foreground and/or background, leading to inaccurate results. The present technology provides for a laser rangefinder with optical zoom function to increase performance of acquisition as relating to distant targets.

### Summary of the Technology

It would be highly advantageous to incorporate zoom (or magnification) optics into a laser-based rangefinder. In addition to this enhanced or magnified view of a target object, the zoom optic structure of the present technology can also serve, in conjunction with an appropriate sensor and the rangefinder's processor, to selectively enhance or magnify the in-sight display information (e.g., the aiming reticle, distance, and the like) as may be desired.

The zoom optic structure of the present technology can be amenable to packaging in a number of different housings and form factors depending upon the desired application. The technology can also be applicable to laser-based rangefinding instruments having a built-in ballistics interface for shooting applications in a monocular or binocular format. The zoom optic structure of the present technology can also be applicable to other laser-based instruments including those generally exhibiting a horizontally disposed form factor inclusive of those devices incorporating image stabilization technology such as stabilized prisms.

Particularly disclosed herein is a zoom optics structure for a rangefinder instrument which comprises first and second lenses moveable with respect to each other and an ocular lens of said rangefinder instrument. The first and second lenses can be positioned in response to a zoom adjuster.

Also disclosed herein is a laser-based rangefinder which comprises a zoom optics structure. The zoom optics structure comprises first and second lenses moveable with respect to each other and an ocular lens of the rangefinder. The first and second lenses can be positioned in response to a zoom adjuster.

Further disclosed herein is a rangefinder including a processor and in-sight display responsive to the processor. The rangefinder comprises a zoom optics structure operatively coupled to a zoom adjuster for providing a magnified image of a target viewed through the rangefinder. In a particular embodiment disclosed herein the position of the zoom adjuster can be operatively communicated to the processor for control of the in-sight display.

Still further disclosed herein is an electronic instrument including a processor for providing a view of a target object. The instrument further comprises an in-sight display responsive to the processor, the in-sight display for superimposing one or more information images on the view of the target object. The instrument further comprises an optical zoom adjuster for providing a magnified view of the target object with the processor operative to sense a position of the zoom adjuster and operatively control the one or more information images on the in-sight display in response thereto.

Also disclosed herein is an alternative embodiment of the present technology wherein the optical zoom adjuster of the present technology may also communicatively operate in conjunction with a processor sensing a position of the zoom adjuster to change a mode of operation of the laser rangefinder. For example, the position of the zoom adjuster can be sensed to change a laser rangefinder's targeting algorithm such that it selects and causes the display of the distance to a nearer object when the instrument's zoom is increased from a wider field of view to a magnified image of a target object in an in-sight display.

Additionally disclosed herein is an electronic instrument including a processor, the instrument for providing a view of a target object. The instrument further comprises an in-sight display responsive to the processor, the in-sight display for superimposing one or more information images on the view of the target object. The instrument further comprises a control device for manually selecting a size of said information images.

### BRIEF DESCRIPTION OF THE DRAWINGS

The aforementioned and other features and objects of the present technology and the manner of attaining them will become more apparent and the technology itself will be best understood by reference to the following description of a preferred embodiment taken in conjunction with the accompanying drawings, wherein:

FIG. 1 is a left side elevational view of a representative laser-based rangefinding instrument;

FIG. 2 is a left side elevational view of the representative laser-based rangefinding instrument of the preceding figure illustrative of certain elements of the internal structure thereof and also showing the addition of an exemplary zoom optics structure in accordance with the present technology, incorporated to the ocular portion of the instrument;

FIG. 3A is a more detailed cross-sectional view of the representative laser-based rangefinding instrument of the preceding figure illustrative of relevant portions of the beam pathway of the target and internal display device view inclusive of the exemplary zoom optics structure;

FIG. 3B is a left side elevational view of a representative laser-based rangefinding instrument of FIG. 1 incorporating an exemplary zoom optics structure in accordance with the present technology;

FIG. 4 is a simplified view of the beam pathway of the laser-based rangefinding instrument of the preceding figures and illustrative of the relationship between the bi-concave lens and plano-convex lenses of a zoom optics structure in both high power and low power configurations together with the structure, focal plane, and the instrument display device;

FIGS. 5A and 5B are further simplified views of the zoom optics structure embodiment of the preceding figure illustrating the structure in a high power and low power configuration respectively;

FIG. 6A illustrates the in-sight target view of a laser-based rangefinding instrument incorporating the function of a zoom optics structure with the zoom optics structure in a low power configuration and with no change to the instrument's display functionality;

FIG. 6B illustrates the in-sight target view of a laser-based rangefinding instrument incorporating the function of a zoom optics structure with the zoom optics structure in a high-power configuration and with an enhancement to the instrument's in-sight display functionality in response to the zoom optics structure;

FIG. 7A illustrates two isometric views of a representative laser-based rangefinding instruments configured in both vertical and horizontal operational positions;

FIG. 7B illustrates the in-sight target view of a laser-based rangefinding instrument incorporating a zoom optics structure wherein the in-sight display is shown rotated 90° while the laser-based rangefinding instruments of the rangefinder shown in FIG. 7A is maintained in a horizontal position;

FIG. 7C illustrates the in-sight target view of a laser-based rangefinding instrument incorporating the function of a zoom optics structure with the zoom optics structure in a high-power configuration view of the target and with reticle size maintained in firmware even while the zoom is increased.

FIG. 8A illustrates a possible external form factor housing implementation of a laser-based rangefinding instrument incorporating a zoom optics structure wherein the battery compartment of the instrument is moved to a different location within the housing;

FIG. 8B illustrates isometric rear and front view of a laser-based rangefinding instrument for possible incorporation of the zoom optics structure for use of the instrument in a horizontal orientation;

FIG. 8C is a simplified isometric illustration of a laser-based rangefinding instrument incorporating the housing form factor of FIG. 8A showing a magnification zoom adjustment ring implementation of a zoom optics structure which may also incorporate laser fire buttons on a top or side surface thereof;

FIG. 8D is an enlarged view of a portion of the embodiment of FIG. 8C wherein access to the magnification zoom adjustment ring would be accorded to a user of the laser-based rangefinding instrument from both the upper and lower surfaces;

FIG. 8E illustrates left side and front views of the laser-based rangefinder of FIG. 1 with corresponding left side and front views of a laser-based rangefinder incorporating the zoom optics structure of the present technology.

FIG. 9 is a simplified functional block diagram of a system whereby the position of the zoom adjustment ring, or zoom adjuster, is communicated to a zoom adjuster position sensor to operatively control aspects of the information presented on the in-sight display; and

FIGS. 10A and 10B are respectively, representative in-sight display information as might be provided in non-zoomed and zoomed modes of operation in, for example, a golf application dedicated laser-based rangefinding instrument of the preceding figures.

### DESCRIPTION OF A REPRESENTATIVE EMBODIMENT

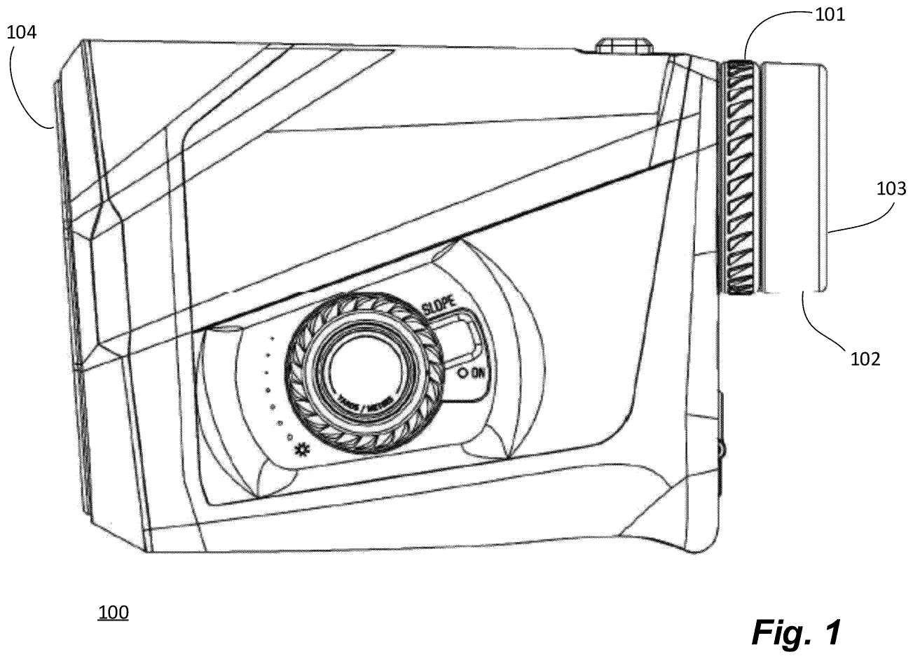

With reference now to FIG. 1, a left side elevational view of a representative laser-based rangefinding instrument 100 is shown. In general, the instrument 100 can include a diopter adjustment ring 101 and an associated eye cup 102 at an ocular end 103 of the instrument 100 as shown. The end of the instrument 100 aimed toward a selected target may be denominated as an objective end 104.

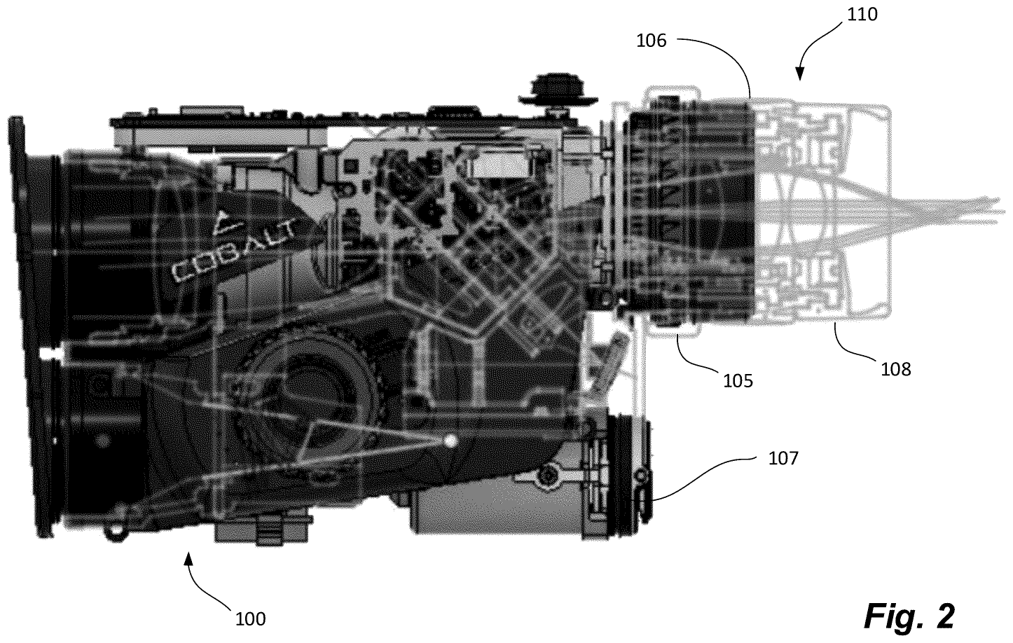

With reference now to FIG. 2, a further left side elevational view of the representative laser-based rangefinding instrument 100 is shown illustrative of the internal structure of the rangefinder and also showing the addition of an exemplary zoom optics structure 110 in accordance with the present technology. The zoom optic structure can be incorporated into the ocular portion of the instrument 100.

The zoom optics structure 110 external components can comprise a zoom adjustment ring (or zoom adjuster) 105, a diopter adjustment ring 106, and an eye cup 108 at the ocular end of the instrument 100. As shown in this figure, the instrument 100 can comprise, among other structures, a battery compartment 107.

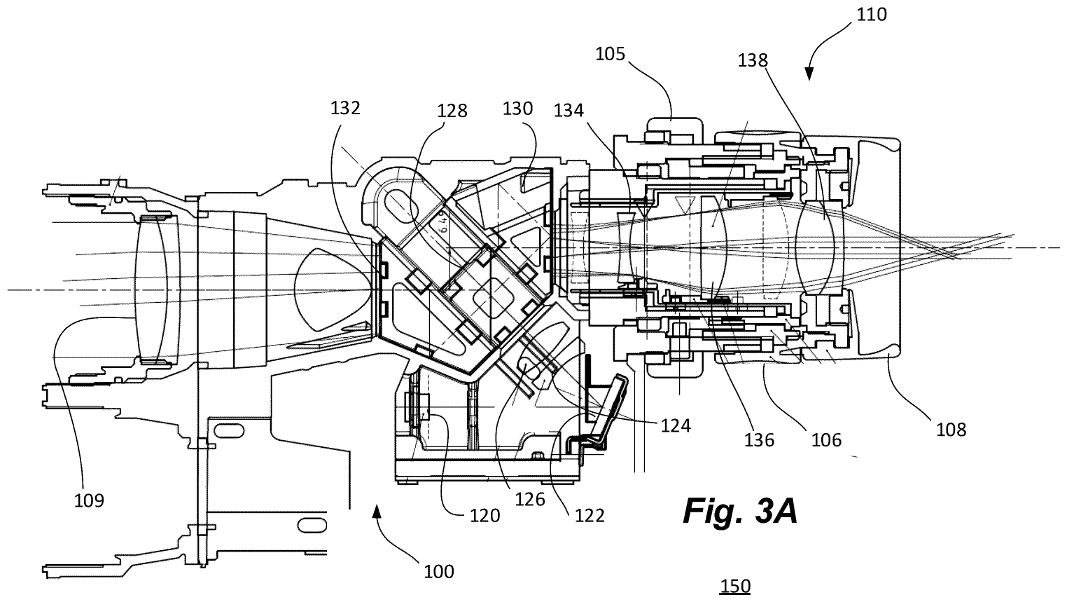

With reference now to FIG. 3A, a more detailed cross-sectional view of the representative laser-based rangefinding instrument 100 is shown illustrative of relevant portions of the beam pathway of the target and internal display device view inclusive of the exemplary zoom optics structure 110.

In this view, the combined laser-based rangefinding instrument 100 and zoom optics structure 110 are shown in a partial, cut-away view inclusive of the zoom optics structure adjustment ring 105, the diopter adjustment ring 106, and eye cup 108.

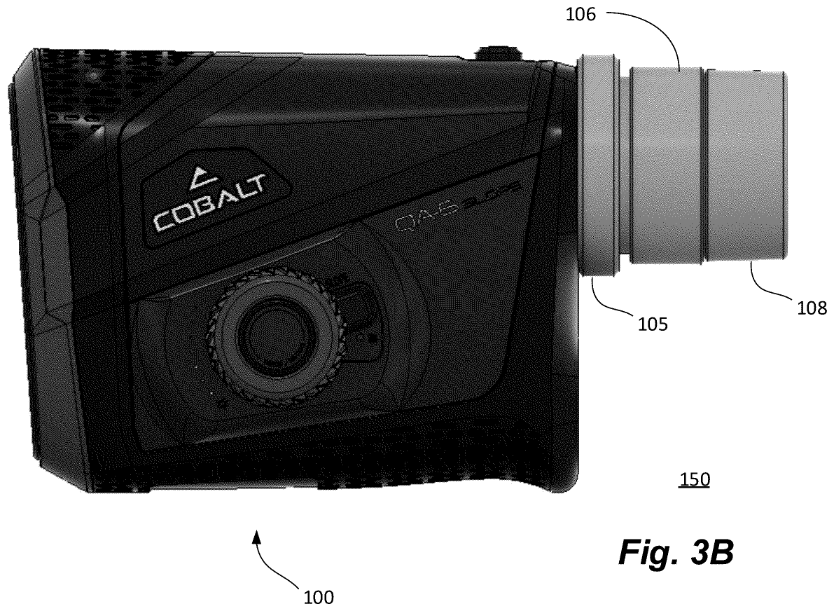

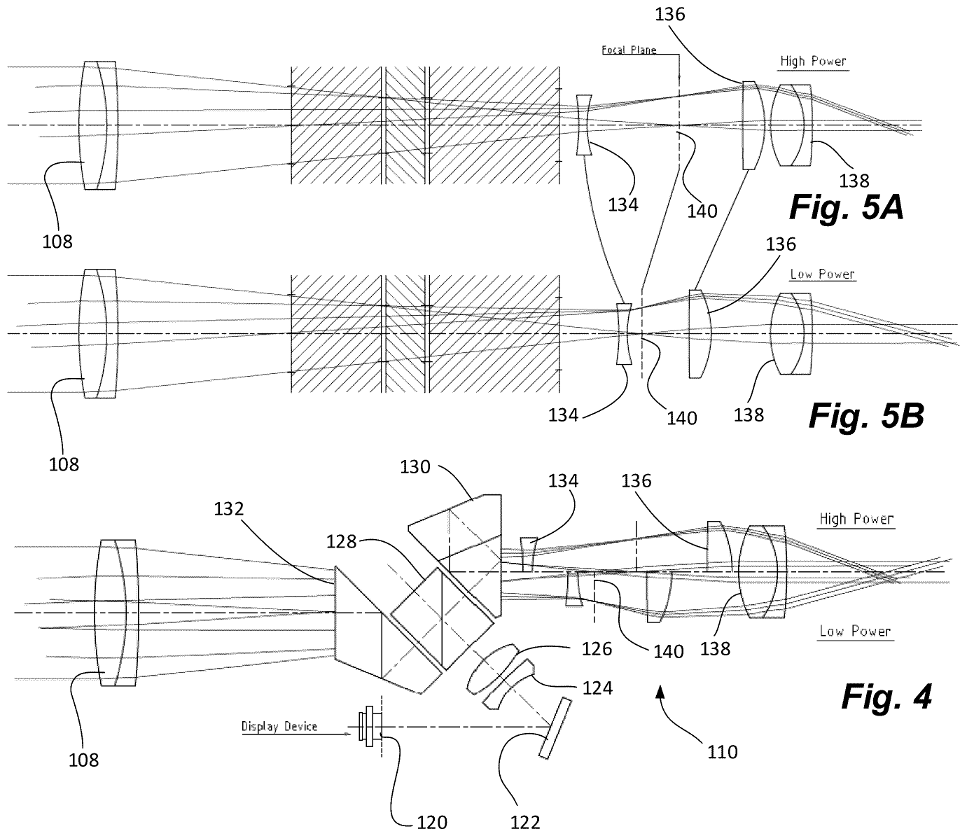

The combined instrument 150 can include an objective lens 109 comprising a bi-convex and plano-concave doublet as shown. A display device 120 can provide a target reticle, distance information, and the like to a mirror 122 which can then direct incident light from the display device 120 to lenses 124 and 126. Light from lens 126 can then be incident upon a beam splitter cube 128 associated with roof prisms 130 and 132. The target and display device 120 optical pathway can further comprise bi-convex lens 134, plano-convex lens 136, and bi-convex and plano-concave doublet lens 138. The relationship between lenses 134, 136, and 138 in the zoom optics structure 110 will be more fully described with respect to subsequent FIGS. 4 and 5A-5B.

With reference additionally now to FIG. 3B, a left side elevational view of a representative laser-based rangefinding instrument 150 is shown incorporating an exemplary zoom optics structure 110 with a laser-based rangefinding instrument 100. This figure illustrates an exemplary instrument 150 comprising a zoom adjustment ring 105, a diopter adjustment ring 106, and an eye cup 108 and is one possible configuration for a laser-based rangefinding instrument 100 in conjunction with the zoom optics structure 110 of the present technology.

With reference now to FIG. 4, a simplified view of the beam pathway of the target and display device 120 views of the representative laser-based rangefinding instrument 150 of the preceding figures is shown. This figure is illustrative of the relationship between the bi-concave lens 134 and plano-convex lens 136 of a zoom optics structure in both high power and low power configurations together with the structure focal plane 140 and the instrument display device 120. As illustrated, as the zoom adjustment ring 105 (FIGS. 2 and 3A-3B) is rotated, this can serve to change the relationship among the lenses 134, 136, and 138 together with the focal plane 140 in high power and low power (magnification) settings.

The lenses 134 and 136 are shown as two separate sections along with changes in the focal plane 140 to illustrate the special relationship between these lenses (with respect to each other and lens 138) as the zoom function of the zoom optics structure 110 is implemented.

With reference now to FIGS. 5A and 5B, further simplified views of the zoom optics structure 110 embodiment of the preceding figure is shown illustrating the structure separately in a high power and low power configuration respectively.

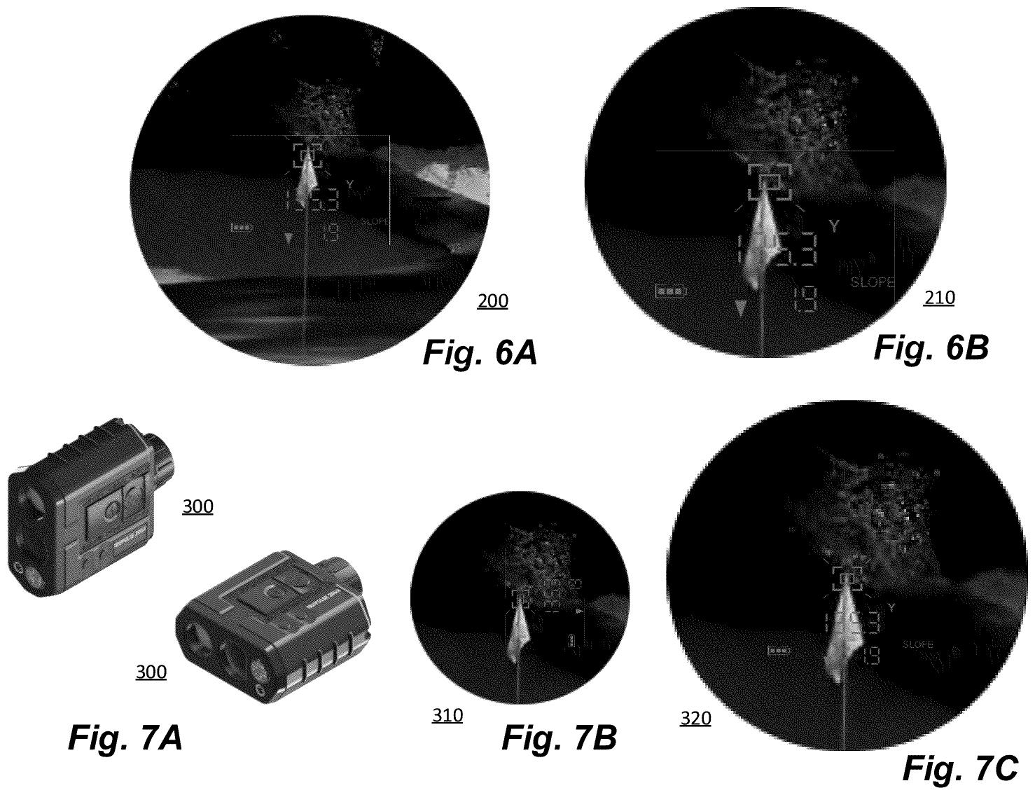

With reference now to FIG. 6A, illustrated is the in-sight target view 200 of a laser-based rangefinding instrument 150 incorporating the function of a zoom optics structure 110 in accordance with the present technology with the zoom optics structure 110 in a low power configuration and with no change to the instrument's display device 120 functionality or magnification level. In this exemplary target view 200, the display device, as controlled by an on-board processor), shows a target reticle, the distance to the target, the slope angle, and the condition of the on-board battery.

A target image zoom of 6×˜12× may be achieved together with an accompanying display device 120 by the zoom optics structure 110. Magnification of approximately 2.0× from a lower magnification to a higher magnification can be determined by the instrument 150 firmware in conjunction with the on-board processor. The zoom adjustment ring 105 may conveniently communicate its current setting to the processor by means of a small magnet embedded in the ring 105, along with a suitable sensor coupled to the processor or other suitable methodology.

With reference now to FIG. 6B, illustrated is the in-sight target view 210 of a laser-based rangefinding instrument 150 incorporating the function of a zoom optics structure 110, with the zoom optics structure 110 in a high-power configuration and with no enhancement to the instrument's in-sight display device 120 functionality. Shown is a zoomed or magnified view of a target object (e.g., a golf hole flag) in response to an increased image zoom, in conjunction with enlarged targeting reticle, distance and/or other information, and/or icons in response to a corresponding increase in the display device magnification.

With reference now to FIG. 7A, illustrated are two isometric views of a representative laser-based rangefinding instruments 300 incorporating the zoom optics structure 110 configured in both vertical and horizontal operational positions.

With reference now to FIG. 7B, illustrated is the in-sight target view 310 of a laser-based rangefinding instrument 300 incorporating a zoom optics structure 150 wherein the in-sight display from the display device 120 is shown rotated 90° while the laser-based rangefinding instruments 300 of the rangefinder shown in FIG. 7A is maintained in a horizontal position. In this particular embodiment, the matrix display from the display device 120 can be used to support both vertical and horizontal laser-based rangefinder 150 orientations as determined by accelerometers or other position sensors in the instruments 300.

With reference now to FIG. 7C, illustrated is the in-sight target view 320 of a laser-based rangefinding instrument 150 incorporating the function of a zoom optics structure 110 with the zoom optics structure 110 in a high-power configuration view of the target and with enhancement to the instrument's in-sight display functionality such that the viewed reticle size is maintained even while there is an increase in the display device magnification. The target reticle, information, and/or icons are shown as not being enlarged such as is illustrated in FIG. 6B.

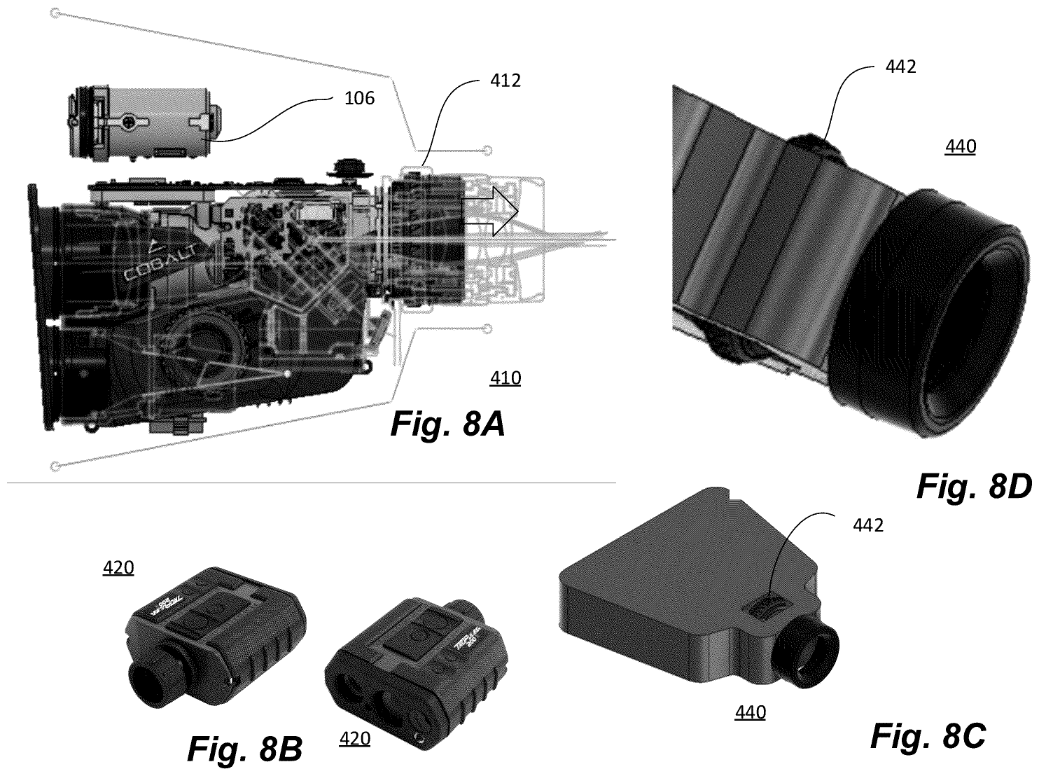

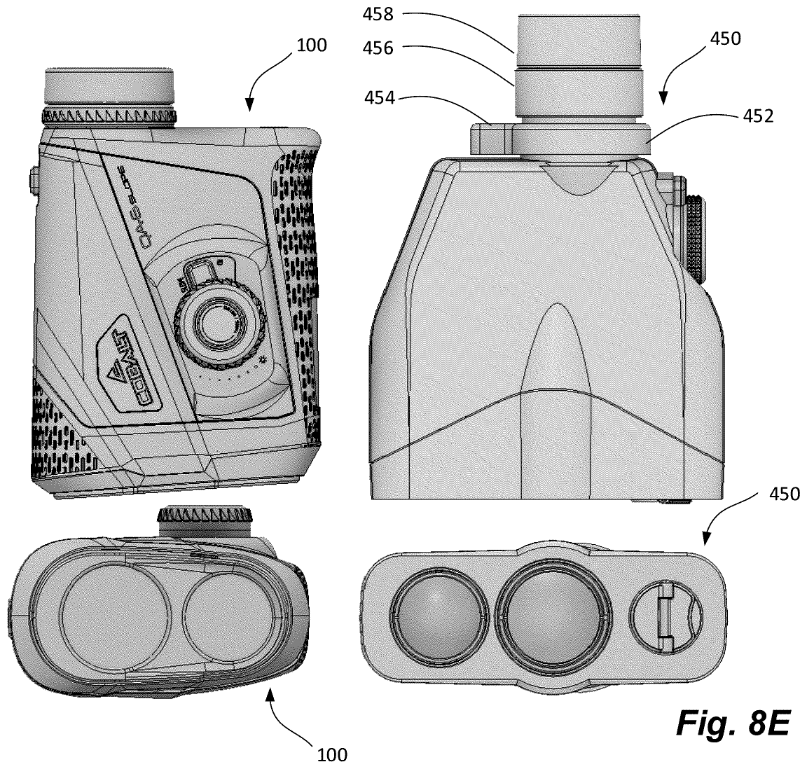

With reference now to FIG. 8A, illustrated is a possible external form factor housing 410 implementation of a laser-based rangefinding instrument 150 incorporating a zoom optics structure 110 wherein the battery compartment 106 of the instrument is moved to a different location within the housing 410. The zoom adjustment ring 412 is illustrated as indicated.

With reference now to FIG. 8B, illustrated are isometric rear and front view of a laser-based rangefinding instrument 420 for incorporation of the zoom optics structure 110 and for use of the instrument 420 in a horizontal orientation.

With reference now to FIG. 8C, a simplified isometric illustration of a laser-based rangefinding instrument 440 incorporating the housing form factor of FIG. 8A is depicted showing a magnification zoom adjustment ring 442 implementation of a zoom optics structure 110 which may also incorporate laser fire buttons on a top or side surface thereof.

With reference now to FIG. 8D, an enlarged view of a portion of the embodiment of the laser-based rangefinder 440. FIG. 8C is shown wherein access to the magnification zoom adjustment ring 442 would be accorded a user of the laser-based rangefinding instrument 440 from both the upper and lower surfaces.

With reference now to FIG. 8E, illustrated are left side and front views of the laser-based rangefinder of FIG. 1 with corresponding left side and front views of an exemplary alternative embodiment 450 of a laser-based rangefinder incorporating the zoom optics structure 110 of the present technology. The embodiment 450 can incorporate a zoom adjustment ring 452 by incorporating a tab (or lever) 454 along with a diopter adjustment ring 456 and eye cup 458.

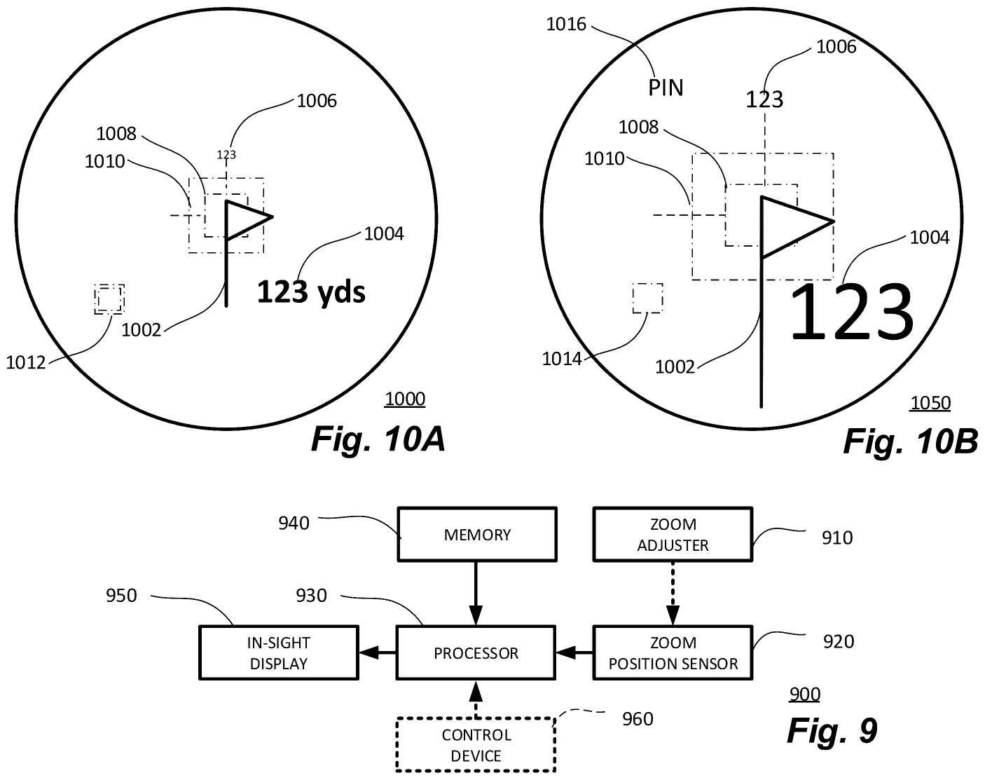

With reference additionally now to FIG. 9, a simplified functional block diagram of a system 900 whereby the position of the zoom adjustment ring of the preceding figures is shown. The position of the zoom adjustment ring or zoom adjuster 910, is communicated to a zoom adjuster position sensor 920 which is coupled to a processor 930. The processor 930 has an associated memory 940 which includes firmware and software configured to affect the types of information such as images, text and the like, their appearance, aspects, position and the like to be displayed on the in-sight display 950 in both a zoom and non-zoomed mode of operation.

With reference additionally now to FIGS. 10A and 10B are respectively illustrated are representative in-sight display information as might be provided in non-zoomed 1000 and zoomed 1050 modes of operation in, for example, a golf application dedicated laser-based rangefinding instrument.

With respect to FIG. 10A in particular, a golf pin 1002 is shown as may be viewed through an optical path of a laser-based rangefinding instrument. The in-sight display 1000 is configured to provide an indication of the calculated distance to the golf pin 1002 as shown by text 1004. This information may also, as an example, be shown in differing text size and a different location at 1006.

A broad aiming reticle 1010 and a more focused aiming reticle 1008 are also shown wherein the distance information at location 1006 and 90° radiating lines from the more focused aiming reticle 1008 may be shown when the laser-based rangefinding instrument distance is locked on the golf pin 1002. Also, illustrated schematically is a representative portion of an illustrated aspect of any displayed image, text or other information wherein in the non-zoomed mode 1000 may comprise two pixels in width at 1012.

With respect particularly to FIG. 10B, a zoomed image of the golf pin 1002 is shown. In this exemplary illustration, the position of the zoom adjustment ring, or zoom adjuster, is sensed such that the information displayed in the non-zoomed mode 1000 of FIG. 10A might be modified in form or placement. Thus, for example, the two-pixel width shown as 1012 in FIG. 10A may now be changed to a one-pixel width as shown at 1014. In addition, the range information at 1004 may be enlarged as shown in FIG. 10B along with the range information 1006 and aiming reticles 1008 and 1010. Still further, additional images or textual information may be illustrated in the in-sight display in a zoomed mode of operation 1050 as shown in FIG. 10B such as “PIN” 1016 when the range is locked on the golf pin 1002.

Referring back also to FIG. 9, the position of the zoom ring or zoom adjuster 910 may be sensed by a zoom position sensor 920 to selectively alter the presentation of any information to be displayed on the instrument's in-sight display 950 in accordance with determined data resident in the memory 940. Such alteration may include changes in placement or type of information to be displayed, the addition of other images or text, or other information which may be desired with respect to a zoomed image viewed through the laser-based rangefinding instrument.

In an alternative embodiment of the present technology, the optical zoom adjuster of the present technology may also communicatively operate in conjunction with a processor sensing a position of the zoom adjuster to change a mode of operation of the laser rangefinder. For example, the position of the zoom adjuster can be sensed to change a laser rangefinder's targeting algorithm such that it selects and causes the display of the distance to a nearer object when the instrument's zoom is increased from a wider field of view to a magnified image of a target object in an in-sight display.

In a still further embodiment of the present technology, a separate control device 960 for providing an adjustment to the in-sight display size may be implemented in lieu of, or in addition to, the sensing of the position of the optical zoom adjuster. In such an embodiment, the control device 960 may comprise a knob on the rangefinding instrument or other means of manually adjusting the size of the aiming reticle, information, and/or icons displayed, regardless of the configuration of the zoom optics structure 110.

While there have been described above the principles of the present invention in conjunction with specific apparatus and zoom optics structure it is to be clearly understood that the foregoing description is made only by way of example and not as a limitation to the scope of the invention. Specifically, while the principles of the invention have been disclosed in conjunction with a laser-based rangefinder for use in sports optics, the principles of the present invention are likewise applicable to rangefinding devices intended for hunting applications incorporating ballistics compensation in shooting applications as well as rangefinding devices incorporating image stabilization functionality. Particularly, it is recognized that the teachings of the foregoing disclosure will suggest other modifications to those persons skilled in the relevant art. Such modifications may involve other features which are already known, per se, and which may be used instead of or in addition to features already described herein. Although claims have been formulated in this application to particular combinations of features, it should be understood that the scope of the disclosure herein also includes any novel feature or any novel combination of features disclosed either explicitly or implicitly or any generalization or modification thereof which would be apparent to persons skilled in the relevant art, whether or not such relates to the same invention as presently claimed in any claim and whether or not it mitigates any or all of the same technical problems as confronted by the present invention. The applicants hereby reserve the right to formulate new claims to such features and/or combinations of such features during the prosecution of the present application or of any further application derived therefrom.

As used herein, the terms “comprises”, “comprising”, or any other variation thereof, are intended to cover a non-exclusive inclusion, such that a process, method, article, or apparatus that comprises a recitation of certain elements does not necessarily include only those elements but may include other elements not expressly recited or inherent to such process, method, article or apparatus. None of the description in the present application should be read as implying that any particular element, step, or function is an essential element which must be included in the claim scope and THE SCOPE OF THE PATENTED SUBJECT MATTER IS DEFINED ONLY BY THE CLAIMS AS ALLOWED. Moreover, none of the appended claims are intended to invoke paragraph six of 35 U.S.C. Sect. 112 unless the exact phrase “means for” is employed and is followed by a participle.

What is claimed is:

1. A laser-based rangefinder comprising a processor and an in-sight display, the rangefinder comprising:
a zoom optics structure, said structure comprising first and second lenses moveable with respect to each other and an ocular lens of said rangefinder, said first and second lenses being positionable in response to a zoom adjuster and wherein a position of said zoom adjuster is operatively communicated to said processor for control of said in-sight display.

2. The rangefinder of claim 1 wherein said first lens comprises a bi-concave lens and said second lens comprises a plano-convex lens.

3. The rangefinder of claim 1 wherein said ocular lens comprises a bi-convex and plano-concave doublet.

4. The rangefinder of claim 1 wherein a targeting mode of said rangefinder is determined by said position of said zoom adjuster as communicated to said processor.

5. The rangefinder of claim 4 wherein said targeting mode selects a nearer target object of said rangefinder as said zoom adjuster increases magnification of said nearer target object.

6. The rangefinder of claim 1 wherein a reticle size of said in-sight display is responsive to said position of said zoom adjuster.

7. The rangefinder of claim 1 further comprising:
a diopter adjustment ring for focusing a target image viewed through said rangefinder.

8. A zoom optics structure for a rangefinder instrument comprising a processor and an in-sight display, said instrument comprising:
first and second lenses moveable with respect to each other and an ocular lens of said rangefinder instrument; said first and second lenses being positionable in response to a zoom adjuster and wherein a position of said zoom adjuster is operatively communicated to said processor for control of said in-sight display.

9. The zoom optics structure of claim 8 wherein said first lens comprises a bi-concave lens and said second lens comprises a plano-convex lens.

10. The zoom optics structure of claim 8 wherein said ocular lens of said rangefinder instrument comprises a bi-convex and plano-concave doublet.

11. The zoom optics structure of claim 8 wherein a targeting mode of said rangefinder is determined by said position of said zoom adjuster as communicated to said processor.

12. The zoom optics structure of claim 11 wherein said targeting mode selects a nearer target object of said rangefinder as said zoom adjuster increases magnification of said nearer target object.

13. The zoom optics structure of claim 8 wherein a reticle size of said in-sight display is responsive to said position of said zoom adjuster.

14. The zoom optics structure of claim 8 further comprising:
a diopter adjustment ring for focusing a target image viewed through said rangefinder instrument.

15. A rangefinder including a processor and in-sight display responsive to said processor, said rangefinder comprising:
a zoom optics structure operatively coupled to a zoom adjuster for providing a magnified image of a target viewed through said rangefinder, wherein a position of said zoom adjuster is operatively communicated to said processor for control of said in-sight display.

16. The rangefinder of claim 15 wherein a reticle size of said in-sight display is responsive to said position of said zoom adjuster.

17. The rangefinder of claim 15 wherein an image of range information indicated in said in-sight display is responsive to said position of said zoom adjuster.

18. An electronic instrument including a processor, said instrument for providing a view of a target object, said instrument further comprising:
an in-sight display responsive to said processor, said in-sight display for superimposing one or more information images on said view of said target object; and
a control device coupled to said processor for manually selecting a size of said information images.

19. An electronic instrument for providing a view of a target object, said instrument comprising:
a processor;
an in-sight display responsive to said processor, said in-sight display for superimposing one or more information images on said view of said target object; and
an optical zoom adjuster for providing a magnified view of said target object, said processor operative to sense a position of said zoom adjuster and operatively control a display of said one or more information images on said in-sight display in response to said zoom adjuster.

20. The instrument of claim 19 wherein said zoom adjuster comprises an annular ring adjacent an eyepiece of said instrument.

21. The instrument of claim 19 wherein said display of said one or more information images on said in-sight display comprises changing a pixel width of said information images on said view of said target object.

22. The instrument of claim 19 wherein said display of said one or more information images on said in-sight display comprises changing a position of said information images on said view of said target object.

23. The instrument of claim 19 wherein said display of said one or more information images on said in-sight display comprises changing a size of said information images on said view of said target object.

24. The instrument of claim 19 wherein said display of said one or more information images on said in-sight display comprises providing one or more additional images or text to said information images on said view of said target object.
